(19) United States
(12) Patent Application Publication
(10) Pub. No.: US 2026/0291791 A1
(43) Pub. Date: Sep. 24, 2026

(54) CONFIGURING REMOTE UNITS TO SUPPORT MULTIPLE NUMEROLOGIES

(71) Applicant: Outdoor Wireless Networks LLC, Richardson, TX (US)

(72) Inventors: Yogesh C.S, Bengaluru (IN); Suresh N. Sriram, Bangalore (IN); Sudarshana Varadappa, Bangalore (IN)

(73) Assignee: Outdoor Wireless Networks LLC, Richardson, TX (US)

(21) Appl. No.: 19/476,484

(22) PCT Filed: Apr. 16, 2024
(86) PCT No.: PCT/US2024/024764

§ 371 Date: Oct. 17, 2025

Related U.S. Application Data
(60) Provisional application No. 63/496,588, filed on Apr. 17, 2023.
(60) Provisional application No. 63/498,407, filed on Apr. 26, 2023.

(51) Int. Cl. H04L 27/26; H04L 41/0895; H04W 88/08

(52) U.S. Cl. CPC H04L 27/26025; H04L 41/0895; H04W 88/085

(57) ABSTRACT

A master unit includes circuitry configured to: receive first configuration data via M-plane from first donor unit communicatively coupled to master unit, wherein first donor unit operates using first numerology associated with first carrier; receive second configuration data via M-plane from second donor unit communicatively coupled to master unit, wherein second donor unit operates using second numerology associated with second carrier; communicate first remote unit configuration data based on first configuration data to first remote unit communicatively coupled to master unit using M-plane, wherein first remote unit is configured to support first carrier using first numerology based on first configuration data; communicate second remote unit configuration data based on second configuration data to second remote unit communicatively coupled to master unit using M-plane, wherein second remote unit is configured to support second carrier using second numerology based on second configuration data.

### CROSS-REFERENCE TO RELATED APPLICATIONS

This application claims the benefit of U.S. Provisional Patent Application Ser. No. 63/498,407, filed on Apr. 26, 2023 and entitled “CONFIGURING REMOTE UNITS TO SUPPORT MULTIPLE NUMEROLOGIES” and U.S. Provisional Patent Application Ser. No. 63/496,588, filed on Apr. 17, 2023 and entitled “WIRELESS COMMUNICATION SYSTEM SUPPORTING MULTIPLE NUMEROLOGIES”, both of which are hereby incorporated herein by reference in their entirety.

### BACKGROUND

Mobile telecommunications systems may use a radio access network (RAN) implementing radio access technology (RAT) to connect user equipment (UE) with a core network (CN).

### SUMMARY

A master unit includes circuitry configured to: receive first configuration data via an M-plane from a first donor unit communicatively coupled to the master unit, wherein the first donor unit operates using a first numerology associated with a first carrier; receive second configuration data via an M-plane from a second donor unit communicatively coupled to the master unit, wherein the second donor unit operates using a second numerology associated with a second carrier; communicate first remote unit configuration data based on the first configuration data to at least a first remote unit communicatively coupled to the master unit using the M-plane, wherein the at least the first remote unit is configured to support the first carrier using the first numerology based on the first configuration data; communicate second remote unit configuration data based on the second configuration data to at least a second remote unit communicatively coupled to the master unit using the M-plane, wherein the at least the second remote unit is configured to support the second carrier using the second numerology based on the second configuration data.

A method includes: receiving first configuration data via an M-plane from a first donor unit communicatively coupled to a master unit of a distributed antenna system, wherein the first donor unit operates using a first numerology associated with a first carrier; receiving second configuration data via an M-plane from a second donor unit communicatively coupled to the master unit of the distributed antenna system, wherein the second donor unit operates using a second numerology associated with a second carrier; communicating first remote unit configuration data based on the first configuration data to at least a first remote unit communicatively coupled to the master unit using the M-plane; configuring the at least the first remote unit to support the first carrier using the first numerology based on the first configuration data; communicate second remote unit configuration data based on the second configuration data to at least a second remote unit communicatively coupled to the master unit using the M-plane; and configuring the at least the second remote unit to support the second carrier using the second numerology based on the second configuration data.

A distributed antenna system includes: a master unit communicatively coupled a first donor unit and a second donor unit using an M-plane, C-plane, and U-plane, wherein the first donor unit operates using a first numerology associated with a first carrier, wherein the second donor unit operates using a second numerology associated with a second carrier; at least a first remote unit communicatively coupled to the master unit using the M-plane, C-plane, and U-plane; at least a second remote unit communicatively coupled to the master unit using the M-plane, C-plane, and U-plane; wherein the master unit is configured to receive first configuration data via the M-plane from the first donor unit; wherein the master unit is configured to receive second configuration data via the M-plane from the second donor unit; wherein the master unit is configured to communicate first remote unit configuration data based on the first configuration data to the at least the first remote unit via the M-plane; wherein the master unit is configured to communicate second remote unit configuration data based on the second configuration data to the at least the second remote unit via the M-plane; wherein the at least the first remote unit is configured to support the first carrier using the first numerology based on the first configuration data; and wherein the at least the second remote unit is configured to support the second carrier using the second numerology based on the second configuration data.

### BRIEF DESCRIPTION OF THE DRAWINGS

Understanding that the drawings depict only exemplary configurations and are not therefore to be considered limiting in scope, the exemplary configurations will be described with additional specificity and detail through the use of the accompanying drawings, in which:

FIGS. 1A-1D are block diagrams illustrating exemplary embodiments of distributed antenna systems (DAS).

FIG. 2 is a block diagram illustrating an exemplary embodiment of a communication system supporting multiple operators having multiple numerologies.

FIG. 3 is a diagram showing a representation of how carriers operating at different symbol timings interact with each other when packets from a plurality of carriers converge with one another.

FIG. 4 is a block diagram illustrating an exemplary embodiment of a communication system supporting multiple operators having multiple numerologies.

FIG. 5 is a flow diagram illustrating a method.

FIG. 6 is a flow diagram illustrating a method.

In accordance with common practice, the various described features are not drawn to scale but are drawn to emphasize specific features relevant to the exemplary configurations.

### DETAILED DESCRIPTION

Communications systems may include a distributed antenna system (DAS), cloud radio access network (C-RAN), virtualized radio access network (vRAN), and/or open radio access network (O-RAN)) with one or more central units or nodes and one or more remotely located access points or antenna units. A distributed antenna system (DAS) typically includes one or more central units or nodes that are communicatively coupled to a plurality of remotely located access points or antenna units, where each access point can be coupled directly to one or more of the central access nodes or indirectly via one or more other remote units and/or via one or more intermediary or expansion units or nodes. A DAS can use either digital transport, analog transport, or combinations of digital and analog transport for generating and communicating the transport signals between the central access nodes, the access points, and any transport expansion nodes.

In a cloud radio access network (C-RAN), geographically separate remote units are controlled by a centralized unit and provide wireless service to user equipment (UEs). In a C-RAN, the centralized unit may communicate with the remote units via a fronthaul network (also referred to as a “fronthaul interface”). In a virtualized radio access network (vRAN) or an open radio access network (O-RAN), the software is further decoupled from the hardware by virtualizing network functions and allowing for commercial off-the-shelf (COTS) hardware to be used within the radio access network instead of proprietary hardware. The O-RAN Alliance promulgates a group of specifications for implementing radio access networks in an open manner. (“O-RAN” is acronym for “Open RAN.”) In O-RAN, each base station is typically implemented in a disaggregated manner in which each base station is partitioned into at least one central unit (CU), at least one distributed unit (DU), and one or more radio units (RUs).

In examples, a communication system integrates multiple operators (such as multiple O-RAN sources/donors) with different numerologies. In examples, an FDD & TDD transport mechanism (C, U, & M plane) are supported separately. In examples, systems include a plurality of RUs operating using a plurality of numerologies. In examples, each numerology will have a different symbol timing. In examples, the packet rate changes based on the PRB size of the carrier considered and the MTU size of the radio configured. In examples, the number of packets is directly related to the PRB size and fragments. In examples, multi-operator, multi numerology transmit and receive handling enforces granularity of symbol timing notion (such as 4.464 microseconds (psec) based on ×16 and approximately 71.36 psec symbol timing of 1 μsec slot notion).

In examples at MU=4 per symbol timing, the master unit (MU) and/or intermediary combining nodes (ICN) in a system need to handle 12 packets in the downlink (DL) and 192 packets in the uplink (UL), which results in a physical resource block (PRB) of 273. In examples, there are 192 packets in the UL when using 32 RUs with four antennas each and three fragments. In examples only two antennas or other numbers of antennas and RUs has been considered as well. In examples, 32 RUs with two antennas and three fragments results in 192 packets minimum. In examples, this can be increased based on the uplink packet rate if there is a special slot where the maximum of the 40 sections of the current rate is supported, 40 sections on the given slot means it will be 40 U-plane packets, which will be like 40 into 32, so that number will again be increased. In examples, this is considered in the nominal range (around 192 packets).

In examples, the system ensures that these packets are being honored at the given symbol notion at this part of the packets. In examples, if you are supporting multiple numerology with multiple operators, each operator with a different numerology has a power of two multiple symbol notion. In examples, the system has to handle many converged packets at a converged symbol notion. In examples, uplink direction I/Q packets for a configured operator/carrier will be received by a number of radio units. In examples, multiple operators/carriers further increase UL I/Q packet loads at MU/ICN units. In examples, MU/ICN units need to gracefully handle every carrier (even with different numerologies), every radio unit, and multiple fragments for each antenna UL I/Q packet at the symbol granularity (in examples, approximately 4.464 microseconds). In examples, handling of multi-operator/carriers, multi-numerology, multi-bandwidth, multi-radio points I/Q packets load gracefully at the MU/ICN modules to ensure end-to-end data sanity is maintained and during the process of handling such high volume of I/Q load ensure the hardware NIC module is properly handle to ensure packet queue subsystem in stable operational state.

In examples, the MU/ICN nodes in the fronthaul are configured to support C-plane, U-plane, and M-planes (such as for O-RAN) using a unified trans-receiver mechanism to support mixed numerologies symbol interval timing and multiple numerologies (such as FDD at 1 microsecond slot transmission time interval (TTI) and TDD at 0.5 or 0.124 microsecond slot transmission time interval (TTI) for 14 symbols per antenna) donor sources simultaneously from a single fronthaul mechanism. In examples, execution of O-RAN C-plane and U-plane transmission and reception of I/Q traffic flow at specific symbol timing should be maintained. In examples, donor source configuration (for C-plane, U-plane, and M-plane) should be relayed (such as by learning and adopting by donor M-plane and configuring O-RU using access M-plane) by MU/ICN nodes toward the RUs and maintaining a synchronized handshake between O-DU (donor) and O-RU units.

In examples, the lowest symbol granularity of the multi numerologies (such as 4.464 microsecond (μs)) will be selected for the C-plane and U-plane operating engine for a DAS. In examples, multiple factors of the lowest symbol duration will be used to support other symbol durations. In examples, this mechanism allows all FDD, TDD, etc. numerologies simultaneous operation, such as with approximately 4.45 microseconds (1×), approximately 8.9 microsecond (2×), approximately 17.85 microsecond (4×), approximately 35.714 microsecond (8×), and approximately 71.42 microsecond (16×) symbol timings.

In examples, the MU/ICN has to have a mechanism to have a single fronthaul timing module defined for both numerologies (such as the lowest granularity of symbol timing interval). In examples, the MU/ICN has additional resources (such as memory buffer (mbuf)) required for C-plane and U-plane based on the defined numerology and intelligence to handle corresponding symbol interval transmission and reception buffers of C-plane and U-plane based on the operator configuration. In examples, the MU/ICN define a virtual function (VF) port and a VLAN per operator. In examples, each VF pair (M-plane, C-plane, and U-plane) serves a donor source and serves the group of RUs based on the operator configuration (including numerology, bandwidth, antenna, etc.)

In examples, 12 packets have been calculated for four antennas and each antenna is three fragments considered as 273 PRB as a carrier. In examples, to handle lover numerologies/sub-carrier spacing, there is an ×2, ×4, ×8, ×16, etc. symbol notion overlap. In examples, at every 16th symbol notion of approximately 4.464 μs, all numerologies converge. In examples, to support I/Q enqueue/deque when the numerologies converge, there is an increase of I/Q packet load on the data plane development kit (DPDK) and network interface controller (NIC) queue system, distributed unit (DU) memory buffer (mbuf), and uplink I/Q intermediate buffers requirement.

In examples where the downlink (DL) includes 60 packets and the uplink (UL) includes 960 packet, there are 1020 packets raw Ethernet load at the DU and DPDK+NIC subsystem. In examples supporting five operators, the 60 packets in the DL is considered 12 packets per carrier into five operators; and the 960 packets in the UL is considered 192 packets per carrier. In examples, this is the raw packet level. In examples, this is the packet rates from the U-plan perspective, but the C-plane will also be present and the packet is one per slot within that configured numerology. In examples, these packets need to be gracefully handled to ensure end-to-end system data sanity. In examples, along with I/Q packets, Control Plane (C-plane) packets will also be significantly increased per virtual function (VF) (such as a donor carrier). In examples, the DL C-plane packets will be 16*4₍ₐₙₜ₎: MU=4; 8*4₍ₐₙₜ₎: MU=3; 4*4₍ₐₙₜ₎: MU=2; 2*4₍ₐₙₜ₎: MU=1; 1*4₍ₐₙₜ₎: MU=0. In examples, UL C-plane packets will be 16*2₍ₐₙₜ₎: MU=4; 8*2₍ₐₙₜ₎: MU=3; 4*2₍ₐₙₜ₎: MU=2; 2*2₍ₐₙₜ₎: MU=1; 1*2₍ₐₙₜ₎: MU=0.

In examples, circuitry (such as a controller, processor, a process running on a server, etc.) is used to implement and/or control a master unit (MU), an intermediary combining node (ICN), and at least one radio unit. In examples, the communication system includes a distributed antenna system (DAS), a cloud radio access network (C-RAN), a virtualized radio access network (vRAN), or an open radio access network (O-RAN).

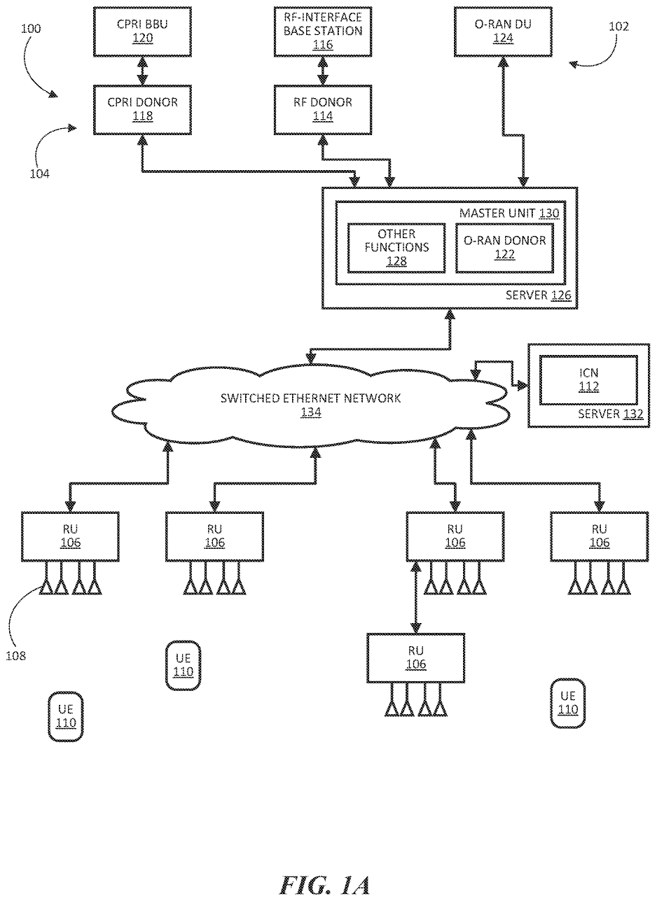

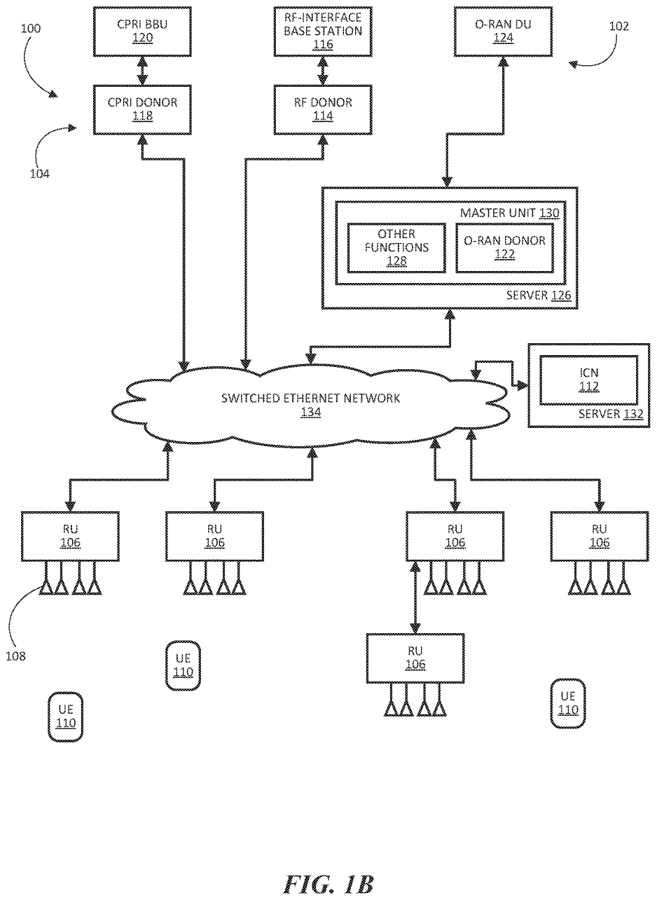

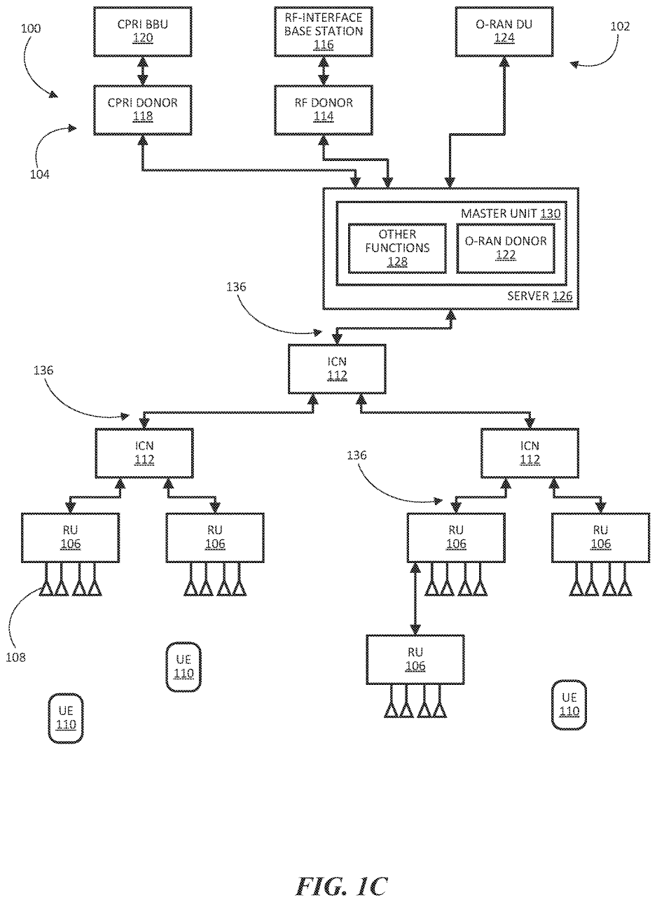

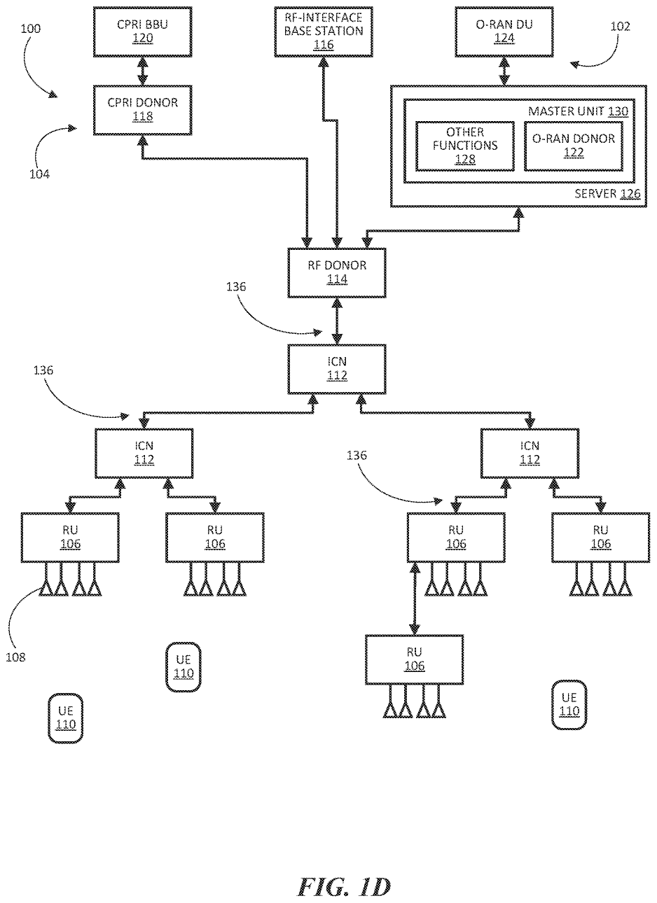

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 108s and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to an O-RAN DU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of O-RAN DU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband I/Q data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any needed combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (I/Q) data from the received uplink transport data and performing a combining or summing process using any uplink I/Q data for that base station 102 in order to produce combined uplink I/Q data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband I/Q data and formatting the resulting digital baseband I/Q data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband I/Q data, and formatting the resulting baseband I/Q data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented by the software. Such hardware or software (or portions thereof) can be implemented in other ways (for example, in an application specific integrated circuit (ASIC), field programmable gate array (FPGA), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106 and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband I/Q data to the master unit 130. The master unit 130 generates downlink O-RAN user-plane messages containing downlink baseband I/Q that is either the time-domain baseband I/Q data provided from the donor units 114 and 118 or is derived therefrom (for example, where the master unit 130 converts the received time-domain baseband I/Q data into frequency-domain baseband I/Q data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband I/Q data contained in those messages in order to produce combined uplink baseband I/Q data, which is provided to the appropriate RF donor unit 114 or CPRI donor unit 118. The RF donor unit 114 or CPRI donor unit 118 uses the combined uplink baseband I/Q data to generate a set of base station signals or CPRI data that is communicated to the corresponding RF-interface base station 116 or CPRI BBU 120. If time-domain baseband I/Q data has been converted into frequency-domain baseband I/Q data for transport over the DAS 100, the donor unit 114 or 118 also converts the combined uplink frequency-domain I/Q data into combined uplink time-domain I/Q data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband I/Q data contained in those messages in order to produce combined uplink I/Q data. The O-RAN donor unit 122 produces O-RAN uplink user-plane messages containing the combined uplink baseband I/Q data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor unit 114 and CPRI donor unit 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband I/Q data and Ethernet data that needs to be communicated to southbound RUs 106 and ICNs 112 that are coupled to the master unit 130 via that point-to-point Ethernet link 136. The downlink time-domain baseband I/Q data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband/Q data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband EQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband I/Q data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband I/Q data and/or encapsulated Ethernet data included in the downlink transport frames communicated via the received downlink transport Ethernet packets. As described above, the RU 106 uses any downlink time-domain baseband I/Q data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband I/Q data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband I/Q data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband I/Q data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband I/Q data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband I/Q data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband I/Q data and/or encapsulated Ethernet data included in the uplink transport frames communicated via the received uplink transport Ethernet packets. Any extracted uplink time-domain baseband I/Q data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 1C, synchronization-plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 1C as being performed by the master unit 130.

When the DAS 100 of any of FIGS. 1A-ID is virtualized as a virtualized DAS (vDAS) 100, virtualization software is executed to implement at least one virtual network function (VNF) running on a server 126. While a single server 126 is shown, it is understood that the at least one virtual network function (VNF) can be implemented using any number of physical servers 126 and that these physical servers can be commercial-off-the-shelf (COTS) hardware. In this description, it should be understood that references to “virtualization” are intended to refer to, and include within their scope, any type of virtualization technology, including “container” based virtualization technology (such as, but not limited to, Kubernetes). In examples, the at least one VNF is implemented using at least one virtual entity (such as Kubernetes Pods, virtual machine(s), container(s), etc.) referred to herein as a vDAS container. In examples, each vDAS container is implemented in a Pod in Kubernetes virtualization environment. In other examples, container or other computing entities are used instead of Kubernetes Pods.

When the DAS 100 of any of FIGS. 1A-1D is virtualized as a vDAS 100, it is especially well-suited for use in deployments in which base stations from multiple wireless service operators share the same vDAS 100 (including, for example, neutral host deployments or deployments where one wireless service operator owns the vDAS 100 and provides other wireless service operators with access to its vDAS 100). The vDAS 100 described here is especially well-suited for use in such deployments because additional virtualized components be easily instantiated in order to support additional wireless service operators. This is the case even if an additional physical server 126 is needed in order to instantiate additional virtualized components because a physical server 126 is either already available in such deployments or can be easily added at a low cost (for example, because of the COTS nature of such hardware).

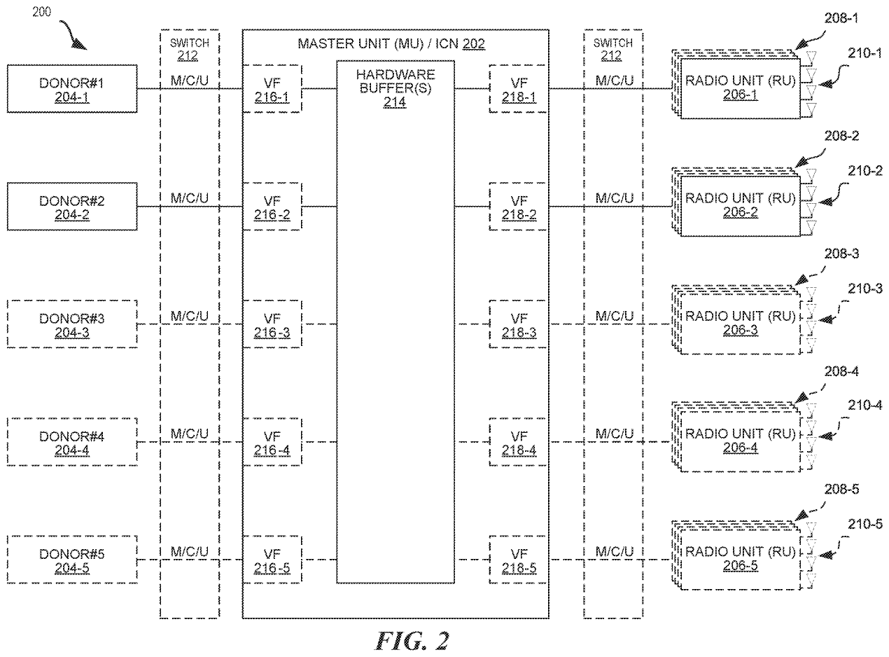

FIG. 2 is a block diagram illustrating an exemplary embodiment of a communication system 200 supporting multiple operators having multiple numerologies. In examples, the communication system 200 is implemented as any of the DAS 100 described above with reference to FIGS. 1A-1D. In examples, the C-plane and U-plane for donors needs to be handled consistently in the system 200 to enable multiple operators with different numerologies to coexist within the system 200. In examples, communication system 200 includes a master unit (MU) and/or intermediary combining node (ICN) 202 communicatively coupled to a plurality of donors 204 and a plurality of radio units (RU) 206 and/or radio unit (RU) clusters 208. In examples the RU clusters are implemented using corresponding virtual local area networks (VLANs).

In examples, the plurality of donors 204 includes donor #1 204-1, donor #2 204-2, donor #3 204-3, donor #4 204-4, and donor #5 204-5. In examples, less than or more than five donors are included in the communication system 200. In examples, the plurality of RUs 206 and/or RU clusters 208 includes a plurality of RU clusters 208, each having a plurality of RUs 206. In examples, the plurality of RU clusters 208 includes RU cluster 208-1 (having a plurality of RUs 206-1), RU cluster 208-2 (having a plurality of RUs 206-2), RU cluster 208-3 (having a plurality of RUs 206-3), RU cluster 208-4 (having a plurality of RUs 206-4), and RU cluster 208-5 (having a plurality of RUs 206-5). In examples, each RU includes or is communicatively coupled to at least one antenna 210 (such as at least one antenna 210-1, at least one antenna 210-2, at least one antenna 210-3, at least one antenna 210-4, at least one antenna 210-5). In examples, the MU/ICN 202 is communicatively coupled to some or all of the plurality of donors 204 through at least one optional switch 212. In examples, the MU/ICN 202 is communicatively coupled to some or all of the RUs and/or RU clusters 208 through at least one optional switch 212.

In examples, the at least one switch 212 is implemented using Ethernet switches. In examples, the M-plane as well as the C-plane and U-plane are communicated between each donor 204 and the MU/ICN 202. In examples, the MU/ICN 202 can be implemented as master unit 130 and/or ICN 112 as shown in FIGS. 1A-1D and described above; the RUs 206 can be implemented as RU 106 as shown in FIGS. 1A-1D and described above; and the coverage antennas 210 can be implemented as coverage antennas 108 shown in FIGS. 1A-1D and described above. In examples, functionality of the MU/ICN 202 is implemented using a controller, processor, a process running on a server, or other types of circuitry. In examples, the functionality of the MU/ICN 202 can be implemented within the server 126 (such as within other VNFs 128) as shown in FIGS. 1A-1D and described above.

In examples, the MU/ICN 202 includes at least one hardware buffer 214 communicatively coupled to the donors 204 via optional virtual functions (VFs) 216 (such as VF 216-1, VF 216-2, VF 216-3, VF 216-4, VF 216-5, or any other number of VFs 216) and communicatively coupled to the RUs 206 and/or RU clusters 208 via optional virtual functions (VFs) 218 (such as VF 218-1, VF 218-2, VF 218-3, VF 218-4, VF 218-5, or any other number of VFs 218). In examples, VFs implement virtual ports on a given physical port for a network interface controller (NIC). In examples, a server includes at least one NIC, each having a logic port it can create. In examples, the data flow for a particular operator from a corresponding donor 204 is handled through a particular VF. In examples, the M-plane, C-plane, and U-plane for each donor 204 is handled by a different VF 216 and VF 218 from the other donors 204 to establish the path between each donor 204 and each corresponding RU 206 and/or RU cluster 208. In examples, the plurality of different donors 204 operate at a plurality of different numerologies. In examples, the at least one hardware buffer 214 is configured to receive packets from the plurality of different donors 204 operating at a plurality of different numerologies. In examples, the at least one hardware buffer 214 is part of at least one NIC. In examples, the MU/ICN 202 operates the DL and the UL in a separate core to avoid latency issues associated with handling both the DL and the UL with a single core.

In examples, the numerologies for the donors have different subcarrier notions and may be selected from the numerologies described in Table 1. In examples, Table 1 shows (for each example numerology 0 through 4) the Sub Carrier Spacing (SCS), the quantity of slots per millisecond (ms), the slot time in microseconds (μs), the quantity of symbols, the symbol timing (how often symbols occur), and the quantity of symbols per 1 millisecond (ms). These are merely example values and may be different in other examples. In examples, the symbol timing (referred to as the symbol notion) is defined as multiple factors of the numerology. In examples, the numerologies are factors of 2, such that numerology 0 has 1 slot per millisecond symbol notion, numerology 1 has 2 slots per millisecond symbol notion, numerology 2 has 4 slots per millisecond symbol notion, numerology 3 has 8 slots per millisecond symbol notion, and numerology 4 has 16 slots per millisecond symbol notion. In examples: (1) donor #1 204-1 operates at numerology 0 with 15 KHz SCS and 1 slot per millisecond; (2) donor #2 204-2 operates at numerology 1 with 30 KHz SCS and 2 slots per millisecond; (3) donor #3 204-3 operates at numerology 2 with 60 KHz SCS and 4 slots per millisecond; (4) donor #4 204-4 operates at numerology 3 with 120 KHz SCS and 8 slots per millisecond; and (5) donor #5 204-5 operates at numerology 4 with 240 KHz SCS and 16 slots per millisecond. In examples, other numerologies, SCS, slots per ms, slot time, symbols, symbol timing, and symbols per ms are used. In examples, the various donors 204 communicate with corresponding RUs 206 and/or RU clusters 208 in both the downlink and the uplink using the corresponding symbol notion.

TABLE 1
Example Numerologies

| | | Slot | Slot | | Sym | Sym |
|---|---|---|---|---|---|---|
| Numer- | | per | Time | | timing | per |
| ology | SCS | 1 ms | (μs) | Symbols | (s) | 1 ms |
| 0 | 15 KHz | 1 | 1000 | 14 | 7.14286E−05 | 14 |
| 1 | 30 KHz | 2 | 500 | 14 | 3.57143E−05 | 28 |
| 2 | 60 KHz | 4 | 250 | 14 | 1.78571E−05 | 56 |
| 3 | 120 KHz | 8 | 125 | 14 | 8.92857E−06 | 112 |
| 4 | 240 KHz | 16 | 62.5 | 14 | 4.46429E−06 | 224 |

In examples, Table 2 shows details regarding quantity of downlink (DL) and uplink (UPL) symbols and slots required to handle embodiments using four antennas and two antennas with 273PRB, compression, reissue, 3K MTU, and 1 ms slot.

TABLE 2
Example Quantity of Downlink (DL) and Uplink (UL) Symbols
Packets to handle (273PRB, compression, reuse, 3K MTU) - 1 msec slot

| DL/Sym(4ant) | UL/Sym(2ant) | DL/Slot(4ant) | UL/Sym(2ant) |
|---|---|---|---|
| 12 | 192 | 176 | 2692 |
| 24 | 384 | 344 | 5380 |
| 48 | 768 | 680 | 10752 |
| 96 | 1536 | 1352 | 21504 |
| 192 | 3072 | 2696 | 43008 |

In examples, Table 3 shows details regarding the downlink (DL) and uplink (UL) packets per slot in the C-plane and the U-plane and the downlink (DL) and uplink (UL) packets per symbol in the U-plane. In examples, Table 3 shows example numerologies and for each example numerology 0 through 4 shows the DL C-plane packets per slot, the UL C-plane packets per slot, the DL U-plane packets per slot, the UL U-plane packets per slot, the DL U-plane packets per slot, and the UL U-plane packets per slot.

TABLE 3
Example Packets Per Slot and Packets Per Symbol in C-Plane and U-Plane

| | | Packets per Slot | | Packets per Slot | | Packets per symbol | |
|---|---|---|---|---|---|---|---|
| | | (C-plane) | | (U-plane) | | (U-plane) | |
| | | DL C- | UL C- | DL U- | UL U- | DL U- | UL U- |
| | Numerology | plane | plane | plane | plane | plane/sym | plane/sym |
| 1 msec | 0 | 40 | 8 | 336 | 2688 | 24 | 192 |
| boundary; | 1 | 80 | 160 | 672 | 5376 | 48 | 384 |
| operating | 2 | 160 | 320 | 1344 | 10752 | 96 | 768 |
| at ~72 usec | 3 | 320 | 640 | 2688 | 21504 | 192 | 1536 |
| symbol notion | 4 | 640 | 1280 | 5376 | 43008 | 384 | 3072 |

In examples, a symbol notion of approximately 4.464 μs is the lowest level of granularity for the numerologies described in Tables 1-3 and thusly the symbol notion of approximately 4.464 μs is compatible with all the numerologies and corresponding symbol notions. In examples, even when uplink packets are received from multiple RUs 206 and/or RU clusters 208, the MU/ICN 202 can gracefully handle all of the packets at the given numerologies by operating the fronthaul at the quickest symbol notion (such as approximately 4.464 μs).

In examples, (1) the donor #1 204-1 carrier may have 12 DL packets and 192 UL packets at approximately 71.42 μs symbol timing (×16 multiplier); (2) the donor #2 204-2 carrier may have 12 DL packets and 192 UL packets at approximately 35.71 μs symbol timing (×8 multiplier); (3) the donor #3 204-3 carrier may have 12 DL packets and 192 UL packets at approximately 17.85 μs symbol timing (×4 multiplier); (4) the donor #4 204-4 carrier may have 12 DL packets and 192 UL packets at approximately 8.92 μs symbol timing (×2 multiplier); and (5) the donor #5 204-5 carrier may have 12 DL and 192 UL packets at approximately 4.464 μs symbol timing (×1 multiplier).

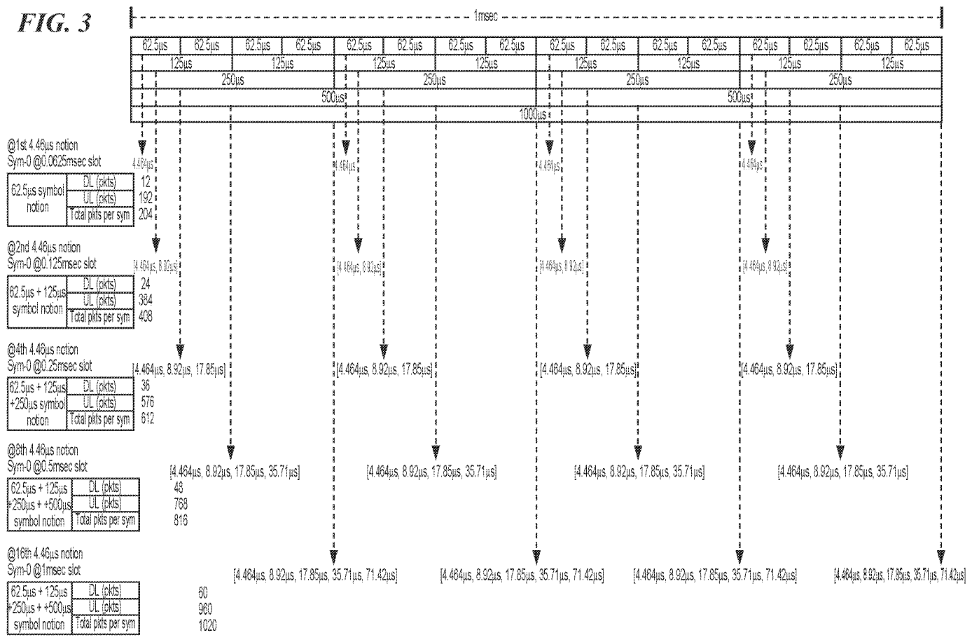

FIG. 3 is a diagram showing a representation of how carriers operating at different symbol timings interact with each other when packets from a plurality of carriers converge with one another. FIG. 3 shows a 1 ms window with five different numerologies and symbol timings. In examples, (1) numerology 0 has a 1000 μs (1 ms) slot time; (2) numerology 1 has a 500 μs (0.5 ms) slot time; (3) numerology 2 has a 250 μs (0.25 ms) slot time; (4) numerology 3 has a 125 μs (0.125 ms) slot time; and (5) numerology 4 has a 62.5 μs (0.625 ms) slot time. In examples, 14 symbols are received in a 62.5 μs (0.625 ms) slot. In examples, the highest granularity of the symbol notion is approximately 4.464 μs, which is 62.5 μs (0.625 ms) divided by 14 symbols. In other examples, other highest granularity symbol notions are determined based on different numerologies, slot times, and/or symbols. In examples, the MU/ICN 202 is configured to poll at the highest granularity symbol notion (such as approximately 4.464 μs in the example shown in FIG. 3.

In examples, the vertical arrows on FIG. 3 show where the different symbol timings converge. In examples, the fifth carrier corresponding to donor #5 204-5 with the numerology of 4 (approximately 4.464 μs symbol timing) converges with: (1) the fourth carrier corresponding to donor #4 204-4 with the numerology of 3 (approximately 8.92 μs symbol timing) approximately every 62.5 μs at symbols of the fourth carrier that occur half as often as symbols of the fifth carrier (such as symbol 2 of the fifth carrier and symbol 1 of the fourth carrier; symbol 4 of the fifth carrier and symbol 2 of the fourth carrier; etc.); (2) the third carrier corresponding to donor #3 204-3 with the numerology of 2 (approximately 17.85 μs symbol timing) approximately every 125 μs at symbols of the third carrier that occur a quarter as often as symbols of the fifth carrier (such as symbol 4 of the fifth carrier and symbol 1 of the third carrier; symbol 8 of the fifth carrier and symbol 2 of the third carrier; etc.); (3) the second carrier corresponding to donor #2 204-2 with the numerology of 1 (approximately 35.71 μs symbol timing) approximately every 250 μsec at symbols of the second carrier that occur an eighth as often as symbols of the fifth carrier (such as symbol 8 of the fifth carrier and symbol 1 of the second carrier; symbol 16 of the fifth carrier and symbol 2 of the second carrier; etc.); and (4) the first carrier corresponding to donor #1 204-1 with the numerology of 0 (approximately 71.42 μs symbol timing) approximately every 500 μs at symbols of the first carrier that occur a sixteenth as often as symbols of the fifth carrier (such as symbol 16 of the fifth carrier and symbol 1 of the first carrier; symbol 32 of the fifth carrier and symbol 2 of the second carrier; etc.).

In examples, the fourth carrier corresponding to donor #4 204-4 with the numerology of 3 (approximately 8.92 μs symbol timing) converges with: (1) the third carrier corresponding to donor #3 204-3 with the numerology of 2 (approximately 17.85 μs symbol timing) approximately every 125 μs at symbols of the third carrier that occur half as often as symbols of the fourth carrier (such as symbol 2 of the fourth carrier and symbol 1 of the third carrier; symbol 4 of the fourth carrier and symbol 2 of the third carrier; etc.); (2) the second carrier corresponding to donor #2 204-2 with the numerology of 1 (approximately 35.71 μs symbol timing) approximately every 250 μsec at symbols of the second carrier that occur a quarter as often as symbols of the fourth carrier (such as symbol 4 of the fourth carrier and symbol 1 of the third carrier; symbol 8 of the fourth carrier and symbol 2 of the third carrier; etc.); and (3) the first carrier corresponding to donor #1 204-1 with the numerology of 0 (approximately 71.42 μs symbol timing) approximately every 500 μs at symbols of the first carrier that occur an eighth as often as symbols of the fourth carrier (such as symbol 8 of the fourth carrier and symbol 1 of the second carrier; symbol 16 of the fourth carrier and symbol 2 of the second carrier; etc.).

In examples, the third carrier corresponding to donor #3 204-3 with the numerology of 2 (approximately 17.85 μs symbol timing) approximately every 125 μs converges with: (1) the second carrier corresponding to donor #2 204-2 with the numerology of 1 (approximately 35.71 μs symbol timing) approximately every 250 μsec at symbols of the second carrier that occur half as often as symbols of the third carrier (such as symbol 2 of the third carrier and symbol 1 of the second carrier; symbol 4 of the third carrier and symbol 2 of the second carrier; etc.); and (2) the first carrier corresponding to donor #1 204-1 with the numerology of 0 (approximately 71.42 μs symbol timing) approximately every 500 μs at symbols of the first carrier that occur a quarter as often as symbols of the third carrier (such as symbol 4 of the third carrier and symbol 1 of the second carrier; symbol 8 of the third carrier and symbol 2 of the second carrier; etc.). In examples, the second carrier corresponding to donor #2 204-2 with the numerology of 1 (approximately 35.71 μs symbol timing) approximately every 250 μsec converges with: (1) the first carrier corresponding to donor #1 204-1 with the numerology of 0 (approximately 71.42 μs symbol timing) approximately every 500 μs at symbols of the first carrier that occur half as often as symbols of the second carrier (such as symbol 2 of the first carrier and symbol 1 of the second carrier; symbol 4 of the first carrier and symbol 1 of the second carrier). In examples, carriers from other numerologies can converge at different times.

In examples, a certain number of packets are expected at a given symbol notion. In examples, dimensioning is performed for the maximum numerology. In examples, dimensioning occurs at a driver level. In examples, the packet size will vary depending on the particular configured carrier and numerology, such that the bandwidth physical resource block (PRB) will be defined based on the bandwidth of the carrier.

In examples where carrier packets converge, the system needs to handle all the packets that converge at that instance. In examples, the system will need to handle 60 downlink packets and 960 uplink packets, totaling to 1020 packets. In examples, the driver is configured to fix the maximum packet rate considering the maximum bandwidth combination. In examples, when the polling misses all the expected packets, the subsequent 4.464 μs are polled from the hardware queue. In examples, there is latency either from the RU 206 or the network delay path, such that the given symbol notion may not see the packet in a current sampling duration, but could in the next sampling duration.

In examples, the MU/ICN 202 is configured to poll at the granularity of the highest numerology (such as approximately 4.464 μs). Simultaneous numerologies have not been previously supported by a single fronthaul module because previous fronthaul modules were only able to take one particular numerology at any time. In previous systems, donors would poll at specific polling rates dictated by the numerology of the donor. In other systems, cell config parameters are relied on to configure the numerology based on the numerology of the donors 204.

This more frequent polling enables the MU/ICN 202 to cover network latency for the smallest offset based on the granularity of the highest numerology (such as approximately 4.464 μs). In examples, while operating at a symbol notion at a granularity of approximately 4.464 μs, the packet sampling rate is offset by only approximately plus or minus 4.464 μs. In examples, there is a sampling rate difference within this offset only. In examples, sampling means taking packet(s) out of the hardware buffer(s) 214 and processing the packet(s) with the Layer 1 (L1) subsystem. In examples, packets arrive at a network interface controller (NIC), the NIC stores the packets in hardware queues that are read by the DPDK subsystem and given to the software L1 subsystem. In examples, even though there may be some latency from the symbol notion perspective, this is addressed by sampling at the next approximately 4.464 μs, during which time the latent packet has arrived and is considered for processing. If a packet still has not arrived by the end of the next approximately 4.464 μs time period, the symbol notion can move onto the next symbol notion and the packet will be in the hardware queue and can be sampled at the next subsequent symbol notion.

In examples, it is expected that all operator packets arrive within a period of time based on a particular numerology (such as approximately 72.2 μs based on a numerology 0). In examples, if a packet does not arrive within that time, the system samples in the next period of time based on the shortest symbol notion for the system (such as approximately 4.464 μs). In this case, the approximately 72.2 μs plus approximately 4.464 μs results in approximately 76.6 μs, which is shorter than waiting until the next period of time for the particular numerology (which would be approximately 144.4 μs) and reduces the latency of packet arrival. In examples, the hardware buffer(s) 214 of the MU/ICN 202 keep receiving packets, including any delayed packets, after the period of time for a particular numerology has passed because packets are delayed and do not always correctly converge. In examples, the delay can be based on multiple factors, such as delays in the driver, the transport medium, and/or the at least one switch 212.

In examples, there is latency in packet arrival from the RU(s) 206 and/or RU cluster(s) 208 and by sampling in subsequent symbol notions, the latent packets can be received by the Layer 1 (L1) subsystem for processing. In examples, the system looks for the specific symbol notions and if the packets have not arrived for the specific symbol notions, the system can go into an offset of 4.464 μs (instead of the full duration for the specific symbol notion) to look for the packet arrival again. In examples, if symbols for a first RU 206 with a particular symbol notion arrives on time, but symbols for a second RU 206 with the same particular symbol notion arrives late (such as by 2 μs), the symbols for the second RU 206 are covered in the offset of the 4.464 μs sampling period.

In examples, the granularity is chosen to be the same as the period of the highest numerology. In examples, network latency causes packets from various RUs 206 to arrive at different times, which results in jitter with respect to the arrival of a packet. In examples, the RUs 206 send packets to the MU/ICN 202 as soon as they are processed and ready to send, but network delay and/or jitter might cause some of the packets to arrive later than the others. In examples, if one RU 206 is on a first hop, a second RU 206 is on a second hop or a fourth hop, there will be network latency associated with the further hop RU 206.

In examples, the MU/ICN 202 does not wait for the numerology specific timing symbol notion timing and instead goes in between to sample at the highest numerology part (approximately 4.464 microseconds) so that the system 200 can honor the packet entirely so that the L1 subsystem performance will be acceptable. In examples, decoding performance is reduced based on packet miss and it may be improved by minimizing packet loss.

In examples, sampling of the hardware buffer(s) 214 occurs multiple times during a symbol instead of just once per symbol. In examples, the MU/ICN 202 employs a unified sampling strategy independent of numerology of the carriers. In examples, no matter how many carriers there are, the different numerologies are sampled at the same rate. In examples, by operating the MU/ICN 202 at the highest numerology, the system can have more flexibility to receive the packet at the earliest and then give it to the L1 subsystem for processing. In examples, with multiple operators, multiple operators operate at the same packet rate and the MU/ICN 202 receives the packets from different operators at the same packet rate simultaneously. In examples, the MU/ICN 202 polls more quickly to digest new packets.

In examples, a similar methodology for sampling of hardware buffer(s) occurring multiple times during a symbol instead of just once per symbol can also be implemented in the RUs 206 for an RU 206 that receives multiple carriers at multiple numerologies. The RUs 206 would also operate at the highest granularity based on the highest numerology of the carriers such that hardware buffer(s) within the RUs 206 can be polled more quickly to catch late arriving packets for any of the carriers at the various numerologies.

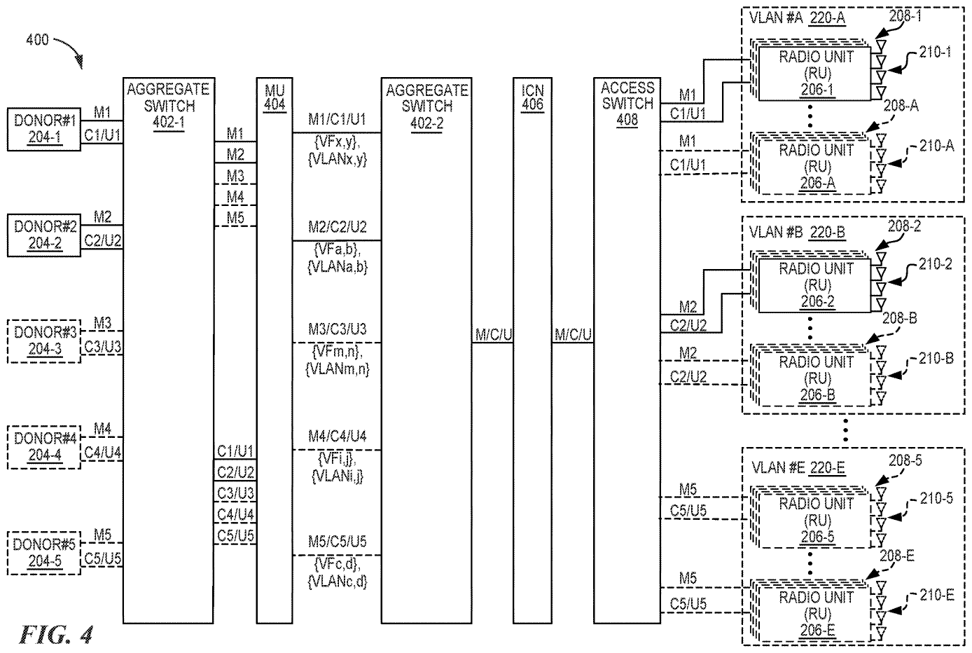

FIG. 4 is a block diagram illustrating an exemplary embodiment of a communication system 400 supporting multiple operators having multiple numerologies. In examples, both the M-plane path and the C-plane and U-plane path through the system 400 are defined for multi-operator and multi-numerology. In examples, the MU and ICN model needs to support multiple M-planes from the various donors. In examples, having multiple M-planes leads to specific configuration parameters which need to be catered to the hardware. In examples, the operator configuration for each donor is transferred to the remote units for the particular donor through the system. In examples, the donor source configuration for each donor is used by the MU to configure the MU, RUs, RU clusters, and other system components to enable the MU to function as the radio for each particular donor. In examples, specific RU clusters are established per donor using a management system for the MU 404, ICN 406, RUs 206, and or RU clusters 208.

In examples, the communication system 400 includes a plurality of donors 204 and a plurality of radio units (RU) 206 and/or RU clusters 206 as described above with reference to FIG. 2. In examples, the plurality of donors 204 includes donor #1 204-1, donor #2 204-2, optional donor #3 204-3, optional donor #4 204-4, and optional donor #5 204-5. In examples, less than or more than five donors are included in the communication system 200. In examples, the plurality of RUs 206 and/or RU clusters 208 includes a plurality of RU clusters 208, each having a plurality of RUs 206. In examples, the plurality of RU clusters 208 includes RU cluster 208-1 (having a plurality of RUs 206-1), optional RU cluster 208-A (having a plurality of optional RUs 206-A), RU cluster 208-2 (having a plurality of RUs 206-2), optional RU cluster 208-B (having a plurality of optional RUs 208-B), optional RU cluster 208-5 (having a plurality of optional RUs 206-5), optional RU cluster 208-E (having a plurality of optional RUs 206-E), and any quantity of optional RUs 206 and optional RU clusters 208. In examples, each RU 206 includes or is communicatively coupled to at least one antenna 210 (such as at least one antenna 210-1, at least one optional antenna 210-A, at least one antenna 210-2, at least one optional antenna 210-B, at least one optional antenna 210-5, at least one optional antenna 210-E, etc.). In examples, each RU 206 and/or RU cluster 208 is part of a virtual local area network (VLAN) 220 (such as VLAN #A 220-A, VLAN #B 220-B, and VLAN #E 220-E). In examples, each VLAN includes a plurality of RUs 206.

In examples, the plurality of donors 204 are communicatively coupled to the RUs 206 through an aggregate switch 402-1, an MU 404, an aggregate switch 402-2, an ICN 406, and an access switch 408. In other examples, greater or fewer quantities of aggregate switches 402, MUs 404, ICNs 406, and access switches 408 are included. In examples, the aggregate switches 402 and the access switch 408 are implemented using Ethernet switches. In examples, the M-plane as well as the C-plane and U-plane are communicated between each donor 204 and the aggregate switch 402-1. In examples, the MU 404 can be implemented as master unit 130 and the ICN can be implemented as ICN 112 as shown in FIGS. 1A-1D and described above; the RUs 206 can be implemented as RU 106 as shown in FIGS. 1A-1D and described above; and the coverage antennas 210 can be implemented as coverage antennas 108 shown in FIGS. 1A-1D and described above. In examples, functionality of the MU 404 and/or ICN 406 is implemented using a controller, processor, a process running on a server, or other types of circuitry. In examples, the functionality of the MU 404 and/or ICN 406 can be implemented within the server 126 (such as within other VNFs 128) as shown in FIGS. 1A-1D and described above.

In examples in the downlink: (1) the aggregate switch 402-1 communicates the M-plane for all of the donors 204 as well as the C-plane and U-plane for all of the donors to the MU 404; (2) the MU 404 communicates the M-plane, C-plane, and U-plane for each donor 204 to the aggregate switch 402-2 which then communicates the M-plane, C-plane, and U-plane for all the donors 204 to the ICN 406; (3) the ICN 406 communicates the M-plane, C-plane, and U-plane for all the donors with the access switch 408; (4) the access switch 408 communicates the M-plane as well as the C-plane and U-plane for each donor to at least one radio unit 206 (such as (1) the M1-plane as well as the C1-plane and U1-plane for donor #1 204-1 being communicated to RU 206-1 and any quantity of RU 206 to optional RU 206-A; (2) the M2-plane as well as the C2-plane and U2-plane for donor #2 204-2 being communicated to RU 206-2 and any quantity of RU 206 to optional RU 206-B; and (3) the M5-plane as well as C5-plane and U5-plane for donor #5 205-5 being communicated to RU 206-5 and any quantity of RU 206 to optional RU 206-E); and (5) the radio units 206 communicate radio frequency signals with user equipment using the at least one antenna 210.

In examples in the uplink: (1) the radio units 206 receive radio frequency signals from user equipment using the at least one antenna 210 and communicate the M-plane as well as the C-plane and U-plane for corresponding donors 204 to the access switch 408; (2) the access switch 408 communicates the M-plane as well as the C-plane and U-plane for the corresponding donors 204 to the ICN 406; (3) the ICN 406 performs uplink combining and communicates the M-plane as well as the C-plane and U-plane for the corresponding donors 204 to the ICN aggregate switch 402-2; (4) the aggregate switch 402-2 communicates the M-plane, the C-plane, and the U-plane for each donor 204 to the MU 404; (5) the MU 404 performs uplink combining and communicates the M-plane as well as the C-plane and U-plane for the corresponding donors 204 to the aggregate switch 402-1; and (6) the aggregate switch 402-1 communicates the M-plane as well as the C-plane and U-plane for each donor 204 to the respective donor 204.

In examples, the M-plane communication from the donors 204 to the MU 404 through the aggregate switch 402-1 is translated by the MU 404 and provided to the RU 206. In examples, the MU 404 and ICN 406 operates together to make the MU 404 appear as a single radio unit to each donor 204. In examples donor managers and/or access managers are used to configure the donor specific RUs 206 for a particular donor 205. In examples, the paths between the various donors 204 and associated RUs 206 are created using the M-plane communication that is received from the various donors 204 at the MU 404 and translated for the RUs 206. Once the M-plane setup through the system 400, then the C-plane and U-plane communication proceeds. In examples, this enables a single MU 404 (single fronthaul module) to implement multiple numerologies for multiple carriers. In examples, the MU 404 selects resources to support C-plane and U-plane traffic for each carrier. In examples, virtual functions (VFs) are used at the MU 404 to implement the virtual port for each donor 204 in connection with each corresponding VLAN 220. In examples, specific RU clusters 208 are established per donor 204.

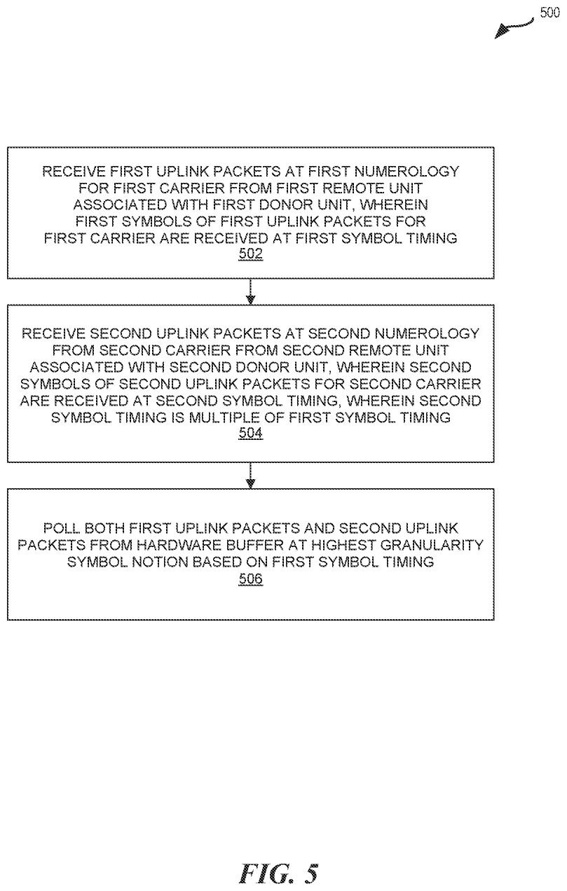

FIG. 5 is a flow diagram illustrating a method 500. In examples, method 500 begins with block 502 with receiving first uplink packets at a first numerology for a first carrier from at least a first remote unit associated with a first donor unit. In examples, first symbols of the first uplink packets for the first carrier are received at a first symbol timing. In examples, method 500 proceeds to block 504 with receiving second uplink packets at a second numerology from a second carrier from at least a second remote unit associated with a second donor unit. In examples, second symbols of the second uplink packets for the second carrier are received at a second symbol timing, wherein the second symbol timing is a multiple of the first symbol timing. In examples, receiving the second uplink packets includes receiving a delayed second uplink packet at the second numerology from the second carrier from the at least the second remote unit associated with the second donor unit. In examples, the delayed second uplink packet is received in a second period of time subsequent to a first period of time during which the delayed second uplink packet was expected.

In examples, method 500 proceeds to block 504 with polling both the first uplink packets and the second uplink packets from the hardware buffer at a highest granularity symbol notion based on the first symbol timing. In examples, the polling includes polling the delayed second uplink packet from the hardware buffer at the first granularity symbol notion during the second period of time subsequent to the first period of time. In examples, the second period of time is shorter than the second symbol timing. In examples, polling more quickly during the second period of time allows for the delayed second uplink packet to be more timely included with the symbol. In examples, the fronthaul unit is selected from a master unit or an intermediary combining node. In examples, the second symbol timing is two times the first symbol timing.

In examples, method 500 further includes receiving third uplink packets at a third numerology for a third carrier from at least a third remote unit associated with a third donor unit. In examples, the third symbols of the third uplink packets for the third carrier are received at a third symbol timing. In examples, method 500 further includes receiving fourth uplink packets at a fourth numerology for a fourth carrier from at least a fourth remote unit associated with a fourth donor unit. In examples, fourth symbols of the fourth uplink packets for the fourth carrier are received at a fourth symbol timing.

In examples, method 500 further includes receiving fifth uplink packets at a fifth numerology for a fifth carrier from at least a fifth remote unit associated with a fifth donor unit. In examples, fifth symbols of the fifth uplink packets for the fifth carrier are received at a fifth symbol timing. In examples, method 500 further includes polling the first uplink packets, the second uplink packets, the third uplink packets, the fourth uplink packets, and the fifth uplink packets from the hardware buffer at the highest granularity symbol notion based on the first symbol timing. In examples, (1) the second symbol timing is two times the first symbol timing; (2) the third symbol timing is four times the first symbol timing; (3) the fourth symbol timing is eight times the first symbol timing; and (4) the fifth symbol timing is sixteen times the first symbol timing.

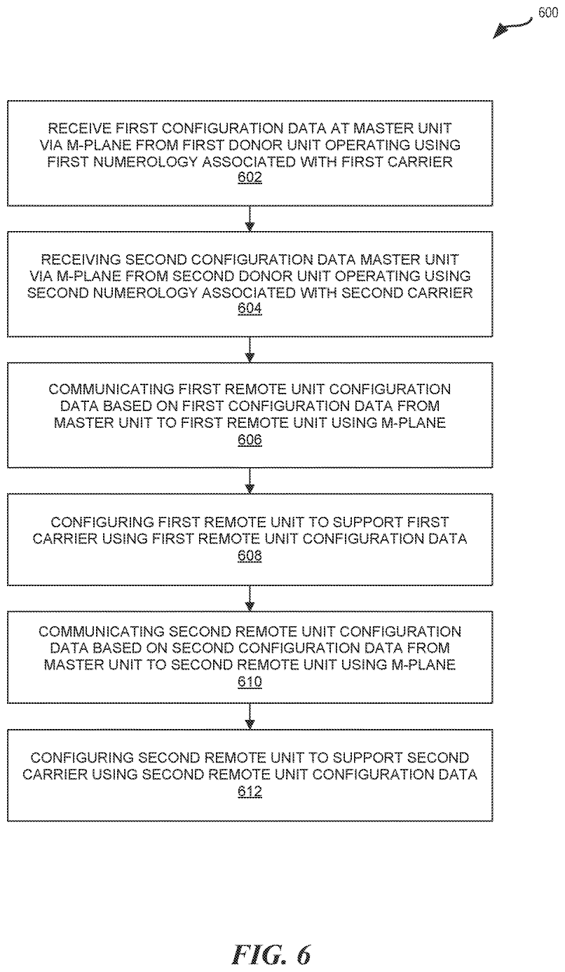

FIG. 6 is a flow diagram illustrating a method 600. In examples, method 600 begins with block 602 with receiving first configuration data via an M-plane from a first donor unit communicatively coupled to a master unit of a distributed antenna system. In examples, the first donor unit operates using a first numerology associated with a first carrier. In examples, method 600 proceeds to block 604 with receiving second configuration data via an M-plane from a second donor unit communicatively coupled to the master unit of the distributed antenna system. In examples, the second donor unit operates using a second numerology associated with a second carrier.

In examples, method 600 proceeds to block 606 with communicating first remote unit configuration data based on the first configuration data to at least a first remote unit communicatively coupled to the master unit using the M-plane. In examples, the first remote unit configuration data is generated based on the first configuration data. In examples, method 600 proceeds to block 608 with configuring the at least the first remote unit to support the first carrier using the first numerology based on the first configuration data. In examples, method 600 proceeds to block 610 with communicating second remote unit configuration data based on the second configuration data from the master unit to at least a second remote unit communicatively coupled to the master unit using the M-plane. In examples, the second remote unit configuration data is generated based on the second configuration data. In examples, method 600 proceeds to block 612 with configuring the at least the second remote unit to support the second carrier using the second numerology based on the second configuration data.

In examples, method 600 further includes: (1) defining a first virtual function port between the first donor unit and the at least the first remote unit for the first carrier based on the first configuration data; and/or (2) defining a second virtual function port between the second donor unit and the at least the second remote unit for the second carrier based on the second configuration data. In examples, method 600 further includes: (1) defining a first virtual local area network (VLAN) between the first donor unit and the at least the first remote unit for the first carrier based on the first configuration data; and/or (2) defining a second VLAN between the second donor unit and the at least the second remote unit for the second carrier based on the second configuration data.

In examples of the method 600, the master unit, the at least the first remote unit, and the at least the second remote unit are part of a distributed antenna system (DAS). In examples of the method 600, the master unit, the at least the first remote unit, the at least the second remote unit, the first donor unit, and the second donor unit are communicatively coupled using at least one Ethernet switch.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### EXAMPLES

Example 1 includes a master unit comprising: circuitry configured to: receive first configuration data via an M-plane from a first donor unit communicatively coupled to the master unit, wherein the first donor unit operates using a first numerology associated with a first carrier; receive second configuration data via an M-plane from a second donor unit communicatively coupled to the master unit, wherein the second donor unit operates using a second numerology associated with a second carrier; communicate first remote unit configuration data based on the first configuration data to at least a first remote unit communicatively coupled to the master unit using the M-plane, wherein the at least the first remote unit is configured to support the first carrier using the first numerology based on the first configuration data; communicate second remote unit configuration data based on the second configuration data to at least a second remote unit communicatively coupled to the master unit using the M-plane, wherein the at least the second remote unit is configured to support the second carrier using the second numerology based on the second configuration data.

Example 2 includes the master unit of Example 1, wherein the circuitry is further configured to: generate the first remote unit configuration data based on the first configuration data; and generate the second remote unit configuration data based on the second configuration data.

Example 3 includes the master unit of any of Examples 1-2, wherein the circuitry is further configured to: define a first virtual function port between the first donor unit and the at least the first remote unit for the first carrier based on the first configuration data; and define a second virtual function port between the second donor unit and the at least the second remote unit for the second carrier based on the second configuration data.

Example 4 includes the master unit of any of Examples 1-3, wherein the circuitry is further configured to: define a first virtual local area network (VLAN) between the first donor unit and the at least the first remote unit for the first carrier based on the first configuration data; and define a second VLAN between the second donor unit and the at least the second remote unit for the second carrier based on the second configuration data.

Example 5 includes the master unit of any of Examples 1-4, wherein the circuitry is configured to: support the first carrier using the first numerology based on the first configuration data by enabling C-plane and U-plane communication between the first donor unit and the first remote unit for the first carrier based on the first configuration data; and support the second carrier using the second numerology based on the second configuration data by enabling C-plane and U-plane communication between the second donor unit and the second remote unit for the second carrier based on the second configuration data.

Example 6 includes the master unit of any of Examples 1-5, wherein the master unit, the at least the first remote unit, and the at least the second remote unit are part of a distributed antenna system (DAS).

Example 7 includes the master unit of any of Examples 1-6, wherein the master unit, the at least the first remote unit, the at least the second remote unit, the first donor unit, and the second donor unit are communicatively coupled using at least one Ethernet switch.

Example 8 includes a method comprising: receiving first configuration data via an M-plane from a first donor unit communicatively coupled to a master unit of a distributed antenna system, wherein the first donor unit operates using a first numerology associated with a first carrier; receiving second configuration data via an M-plane from a second donor unit communicatively coupled to the master unit of the distributed antenna system, wherein the second donor unit operates using a second numerology associated with a second carrier; communicating first remote unit configuration data based on the first configuration data to at least a first remote unit communicatively coupled to the master unit using the M-plane; configuring the at least the first remote unit to support the first carrier using the first numerology based on the first configuration data; communicate second remote unit configuration data based on the second configuration data to at least a second remote unit communicatively coupled to the master unit using the M-plane; and configuring the at least the second remote unit to support the second carrier using the second numerology based on the second configuration data.

Example 9 includes the method of Example 8, further comprising: generating the first remote unit configuration data based on the first configuration data; and generating the second remote unit configuration data based on the second configuration data.

Example 10 includes the method of any of Examples 8-9, further comprising: defining a first virtual function port between the first donor unit and the at least the first remote unit for the first carrier based on the first configuration data; and defining a second virtual function port between the second donor unit and the at least the second remote unit for the second carrier based on the second configuration data.

Example 11 includes the method of any of Examples 8-10, further comprising: defining a first virtual local area network (VLAN) between the first donor unit and the at least the first remote unit for the first carrier based on the first configuration data; and defining a second VLAN between the second donor unit and the at least the second remote unit for the second carrier based on the second configuration data.

Example 12 includes the master unit of any of Examples 1-11, further comprising: supporting the first carrier using the first numerology based on the first configuration data by enabling C-plane and U-plane communication between the first donor unit and the first remote unit for the first carrier based on the first configuration data; and supporting the second carrier using the second numerology based on the second configuration data by enabling C-plane and U-plane communication between the second donor unit and the second remote unit for the second carrier based on the second configuration data.

Example 13 includes the method of any of Examples 8-12, wherein the master unit, the at least the first remote unit, and the at least the second remote unit are part of a distributed antenna system (DAS).

Example 14 includes the method of any of Examples 8-13, wherein the master unit, the at least the first remote unit, the at least the second remote unit, the first donor unit, and the second donor unit are communicatively coupled using at least one Ethernet switch.

Example 15 includes a distributed antenna system, the distributed antenna system comprising: a master unit communicatively coupled a first donor unit and a second donor unit using an M-plane, C-plane, and U-plane, wherein the first donor unit operates using a first numerology associated with a first carrier, wherein the second donor unit operates using a second numerology associated with a second carrier; at least a first remote unit communicatively coupled to the master unit using the M-plane, C-plane, and U-plane; at least a second remote unit communicatively coupled to the master unit using the M-plane, C-plane, and U-plane; wherein the master unit is configured to receive first configuration data via the M-plane from the first donor unit; wherein the master unit is configured to receive second configuration data via the M-plane from the second donor unit; wherein the master unit is configured to communicate first remote unit configuration data based on the first configuration data to the at least the first remote unit via the M-plane; wherein the master unit is configured to communicate second remote unit configuration data based on the second configuration data to the at least the second remote unit via the M-plane; wherein the at least the first remote unit is configured to support the first carrier using the first numerology based on the first configuration data; and wherein the at least the second remote unit is configured to support the second carrier using the second numerology based on the second configuration data.

Example 16 includes the distributed antenna system of Example 15, wherein the master unit is further configured to: generate the first remote unit configuration data based on the first configuration data; and generate the second remote unit configuration data based on the second configuration data.

Example 17 includes the distributed antenna system of any of Examples 15-16, wherein the master unit is further configured to: define a first virtual function port between the first donor unit and the at least the first remote unit for the first carrier based on the first configuration data; and define a second virtual function port between the second donor unit and the at least the second remote unit for the second carrier based on the second configuration data.

Example 18 includes the distributed antenna system of any of Examples 15-17, wherein the master unit is further configured to: define a first virtual local area network (VLAN) between the first donor unit and the at least the first remote unit for the first carrier based on the first configuration data; and define a second VLAN between the second donor unit and the at least the second remote unit for the second carrier based on the second configuration data.

Example 19 includes the distributed antenna system of any of Examples 15-18, wherein the master unit is further configured to: support the first carrier using the first numerology based on the first configuration data by enabling C-plane and U-plane communication between the first donor unit and the first remote unit for the first carrier based on the first configuration data; and support the second carrier using the second numerology based on the second configuration data by enabling C-plane and U-plane communication between the second donor unit and the second remote unit for the second carrier based on the second configuration data.

Example 20 includes the distributed antenna system of any of Examples 15-19, wherein the master unit, the at least the first remote unit, the at least the second remote unit, the first donor unit, and the second donor unit are communicatively coupled using at least one Ethernet switch.

1. A master unit comprising:
circuitry configured to:
receive first configuration data via an M-plane from a first donor unit communicatively coupled to the master unit, wherein the first donor unit operates using a first numerology associated with a first carrier;
receive second configuration data via the M-plane from a second donor unit communicatively coupled to the master unit, wherein the second donor unit operates using a second numerology associated with a second carrier;
communicate first remote unit configuration data based on the first configuration data to at least a first remote unit communicatively coupled to the master unit using the M-plane, wherein the at least the first remote unit is configured to support the first carrier using the first numerology based on the first configuration data; and
communicate second remote unit configuration data based on the second configuration data to at least a second remote unit communicatively coupled to the master unit using the M-plane, wherein the at least the second remote unit is configured to support the second carrier using the second numerology based on the second configuration data.

2. The master unit of claim 1, wherein the circuitry is further configured to:
generate the first remote unit configuration data based on the first configuration data; and
generate the second remote unit configuration data based on the second configuration data.

3. The master unit of claim 1, wherein the circuitry is further configured to:
define a first virtual function port between the first donor unit and the at least the first remote unit for the first carrier based on the first configuration data; and
define a second virtual function port between the second donor unit and the at least the second remote unit for the second carrier based on the second configuration data.

4. The master unit of claim 1, wherein the circuitry is further configured to:
define a first virtual local area network (VLAN) between the first donor unit and the at least the first remote unit for the first carrier based on the first configuration data; and
define a second VLAN between the second donor unit and the at least the second remote unit for the second carrier based on the second configuration data.

5. The master unit of claim 1, wherein the circuitry is configured to:
support the first carrier using the first numerology based on the first configuration data by enabling C-plane and U-plane communication between the first donor unit and the first remote unit for the first carrier based on the first configuration data; and
support the second carrier using the second numerology based on the second configuration data by enabling the C-plane and U-plane communication between the second donor unit and the second remote unit for the second carrier based on the second configuration data.

6. The master unit of claim 1, wherein the master unit, the at least the first remote unit, and the at least the second remote unit are part of a distributed antenna system (DAS).

7. The master unit of claim 1, wherein the master unit, the at least the first remote unit, the at least the second remote unit, the first donor unit, and the second donor unit are communicatively coupled using at least one Ethernet switch.

8. A method comprising:
receiving first configuration data via an M-plane from a first donor unit communicatively coupled to a master unit of a distributed antenna system, wherein the first donor unit operates using a first numerology associated with a first carrier;
receiving second configuration data via the M-plane from a second donor unit communicatively coupled to the master unit of the distributed antenna system, wherein the second donor unit operates using a second numerology associated with a second carrier;
communicating first remote unit configuration data based on the first configuration data to at least a first remote unit communicatively coupled to the master unit using the M-plane;
configuring the at least the first remote unit to support the first carrier using the first numerology based on the first configuration data;
communicate second remote unit configuration data based on the second configuration data to at least a second remote unit communicatively coupled to the master unit using the M-plane; and
configuring the at least the second remote unit to support the second carrier using the second numerology based on the second configuration data.

9. The method of claim 8, further comprising:
generating the first remote unit configuration data based on the first configuration data; and
generating the second remote unit configuration data based on the second configuration data.

10. The method of claim 8, further comprising:
defining a first virtual function port between the first donor unit and the at least the first remote unit for the first carrier based on the first configuration data; and
defining a second virtual function port between the second donor unit and the at least the second remote unit for the second carrier based on the second configuration data.

11. The method of claim 8, further comprising:
defining a first virtual local area network (VLAN) between the first donor unit and the at least the first remote unit for the first carrier based on the first configuration data; and
defining a second VLAN between the second donor unit and the at least the second remote unit for the second carrier based on the second configuration data.

12. The method of claim 8, further comprising:
supporting the first carrier using the first numerology based on the first configuration data by enabling C-plane and U-plane communication between the first donor unit and the first remote unit for the first carrier based on the first configuration data; and
supporting the second carrier using the second numerology based on the second configuration data by enabling the C-plane and U-plane communication between the second donor unit and the second remote unit for the second carrier based on the second configuration data.

13. The method of claim 8, wherein the master unit, the at least the first remote unit, and the at least the second remote unit are part of the distributed antenna system (DAS).

14. The method of claim 8, wherein the master unit, the at least the first remote unit, the at least the second remote unit, the first donor unit, and the second donor unit are communicatively coupled using at least one Ethernet switch.

15. A distributed antenna system, the distributed antenna system comprising:
a master unit communicatively coupled a first donor unit and a second donor unit using an M-plane, a C-plane, and a U-plane, wherein the first donor unit operates using a first numerology associated with a first carrier, wherein the second donor unit operates using a second numerology associated with a second carrier;
at least a first remote unit communicatively coupled to the master unit using the M-plane, the C-plane, and the U-plane;
at least a second remote unit communicatively coupled to the master unit using the M-plane, the C-plane, and the U-plane;
wherein the master unit is configured to receive first configuration data via the M-plane from the first donor unit;
wherein the master unit is configured to receive second configuration data via the M-plane from the second donor unit;
wherein the master unit is configured to communicate first remote unit configuration data based on the first configuration data to the at least the first remote unit via the M-plane;
wherein the master unit is configured to communicate second remote unit configuration data based on the second configuration data to the at least the second remote unit via the M-plane;
wherein the at least the first remote unit is configured to support the first carrier using the first numerology based on the first configuration data; and
wherein the at least the second remote unit is configured to support the second carrier using the second numerology based on the second configuration data.

16. The distributed antenna system of claim 15, wherein the master unit is further configured to:
generate the first remote unit configuration data based on the first configuration data; and
generate the second remote unit configuration data based on the second configuration data.

17. The distributed antenna system of claim 15, wherein the master unit is further configured to:
define a first virtual function port between the first donor unit and the at least the first remote unit for the first carrier based on the first configuration data; and
define a second virtual function port between the second donor unit and the at least the second remote unit for the second carrier based on the second configuration data.

18. The distributed antenna system of claim 15, wherein the master unit is further configured to:
define a first virtual local area network (VLAN) between the first donor unit and the at least the first remote unit for the first carrier based on the first configuration data; and
define a second VLAN between the second donor unit and the at least the second remote unit for the second carrier based on the second configuration data.

19. The distributed antenna system of claim 15, wherein the master unit is further configured to:
support the first carrier using the first numerology based on the first configuration data by enabling C-plane and U-plane communication between the first donor unit and the first remote unit for the first carrier based on the first configuration data; and
support the second carrier using the second numerology based on the second configuration data by enabling the C-plane and U-plane communication between the second donor unit and the second remote unit for the second carrier based on the second configuration data.

20. The distributed antenna system of claim 15, wherein the master unit, the at least the first remote unit, the at least the second remote unit, the first donor unit, and the second donor unit are communicatively coupled using at least one Ethernet switch.
